(19) United States
(12) Patent Application Publication
(10) Pub. No.: US 2014/0000150 A1
(43) Pub. Date: Jan. 2, 2014

(54) Multicolored Artificial Bait

(71) Applicant: SH GLOBAL CO., LTD., Jeollabuk-do (KR)

(72) Inventors: Seung Hoon RYU, Incheon (KR); Seung Yeon RYU, Seoul (KR)

(21) Appl. No.: 13/932,292

(22) Filed: Jul. 1, 2013

(30) Foreign Application Priority Data
Jun. 29, 2012 (KR) 10-2012-0071205
May 8, 2013 (KR) 10-2013-0051796

(51) Int. Cl. A01K 85/01; A01K 85/00

(52) U.S. Cl. CPC A01K 85/01; A01K 85/00
USPC 43/42.32

(57) ABSTRACT

A multicolored artificial bait, where the color of an artificial bait changes in response to the transmission of sunlight and water temperature at a given depth. According to one embodiment, the target fish can be effectively attracted by way of a single color-changing artificial bait; the attractive effect is further enhanced by the fact that the overall color of the artificial bait is changed. In addition, because a single artificial bait can be used without regard to season or depth, user convenience is improved.

### CROSS-REFERENCE TO RELATED APPLICATIONS

This application claims priority to Korean Patent Application No. 10-2012-0071205 Filed 29 Jun. 2012 and Korean Patent Application No. 10-2013-0051796 filed 8 May 2013 the disclosures of which are incorporated in their entirety by reference herein.

### TECHNICAL FIELD

This invention relates to a multicolored artificial bait, and more specifically to an invention wherein the color of an artificial bait changes in response to the transmission of sunlight and the temperature at a given depth.

### BACKGROUND

Fish such as mackerel, sardines or squid are frequently used to catch fish. When fish are used as bait in this fashion, the bait must be kept stored frozen to prevent decomposition, and freezer facilities are consequently needed, and thawing facilities are also needed in order to thaw out the frozen bait. In addition, fuel consumption is also increased, because additional fuel is required to operate these freezing and thawing facilities.

Furthermore, if fresh fish is used as bait, it is problematic to reuse the bait after a single use, because the fish can easily decompose in a short time. Therefore, because bait that has been used once must be thrown away and new bait used, the quantity of bait used is increased, and the problem arises of having to change the bait each time the net is cast, and in addition, the quantity of catch is reduced because the operating time is shortened.

However, various artificial baits are being provided in order to address this issue.

More specifically, the artificial bait is attached to a fish hook, and attracts the target fish by having a shape and motion similar to the prey of the target fish. Conventional artificial baits include plug lures, worms, etc.; the target fish are generally known to be attracted by the shapes and colors of the artificial baits.

In addition, there are types of artificial baits that continuously and gradually descend within the water in order to effectively attract fish and shellfish, but artificial baits of the prior art have poor ability to attract fish and shellfish, because they decompose or fall into large clumps in a comparatively short time.

According to the prior art relevant to this invention, the surface of an artificial bait (10) such as a plug lure modeled on a fish is given the actual color and shape of a fish, thus inducing aggression in the target fish. In particular, because the color of artificial bait induces substantial aggression in the target fish and is effective in attracting the target fish, manufacturers are highly interested in the color of artificial baits.

In addition, looking over the methods of manufacture of artificial baits having various colors according to the prior art, by way of example, a method is used involving fabrication by cladding with two or more metals, oxides or intermetallic compounds having respectively unique colors. However, such a method has the drawbacks of increased manufacturing costs and the ability to realize only a limited range of colors.

### SUMMARY

### Problem that the Invention is Intended to Solve

This invention has been devised in order to address the above problems. More specifically, this invention seeks to provide a multicolored artificial bait that changes colors due to the transmission of sunlight or temperature at a given depth.

In addition, it is sought to provide a multicolored artificial bait having a plurality of reacting zones and colors.

### Means of Solving the Problem

In order to accomplish the above-described task, this invention provides a multicolored artificial bait, characterized in that it has a plurality of pre-set temperature zones, contains microcapsules that manifest pre-set colors corresponding to the respective temperature zones, and is used in fishing for perciform fish.

It is further preferred that said perciform fish be any one selected from among the group comprising the Percichthyidae, Serranidae, Polyprionidae, Nototheniidae, Moronidae and Centrarchidae.

It is further preferred that said perciform fish be any one selected from among the group comprising Australian bass (Macquaria novemaculeata), black sea bass (Centropristis striata), giant sea bass (Stereolepis gigas), Patagonian toothfish (Dissostichus eleginoides), European seabass (Dicentrarchus labrax), largemouth bass (Micropterus salmoides), smallmouth bass (Micropterus dolomieu), striped bass (Morone saxatilis), and spotted bass (Micropterus punctulatus).

It is further preferred that said microcapsules be one or more of temperature-sensitive and light-sensitive.

It is further preferred that said plurality of pre-set temperature zones be determined by one or more from among the transmission of sunlight and temperature at a given depth.

It is further preferred that said plurality of pre-set temperature zones comprise four zones based on depth.

It is further preferred that said four zones be a 1st zone, 2nd zone, 3rd zone, and 4th zone, at intervals of 2 m from the water surface.

It is further preferred that said multicolored artificial bait manifest at least one or more colors selected from among the group comprising white, blue, and purple, in said 1st zone.

It is further preferred that said multicolored artificial bait manifest a green-type color in said 2nd zone.

It is further preferred that said multicolored artificial bait manifest at least one or more of gold-type and pink-type colors in said 3rd zone.

It is further preferred that said multicolored artificial bait manifest a red-type color in said 4th zone.

It is further preferred that said microcapsules be from 0.1 to 5% of the total weight.

### Effects of the Invention

According to one embodiment of this invention, a multicolored artificial bait is provided that changes color based on sunlight transmission or temperature at a given depth, whereby the target species of fish can be effectively attracted with a single artificial bait.

In addition, the attraction effect is further enhanced by the change in the overall color of the artificial bait.

In addition, catch performance can be increased by manifesting the most effective color for attracting the target fish species at the relevant depth, based on the temperature or the transmission of sunlight.

In addition, user convenience is improved, because a single artificial bait can be used regardless of depth or time of year.

### BRIEF DESCRIPTION OF THE DRAWINGS

FIG. 1 is a perspective view of an artificial bait of the prior art.

FIG. 2 shows the change in color of an artificial bait according to one embodiment of this invention.

FIG. 3 is a graph comparing the visual acuity of humans and bass with respect to water turbidity.

FIG. 4 is a schematic drawing illustrating how the growth of aquatic plants and phytoplankton is determined by the transmission of light.

FIG. 5 is a graph showing the relationship between bass and water temperature.

FIG. 6 illustrates the color of transmitted sunlight at different depths.

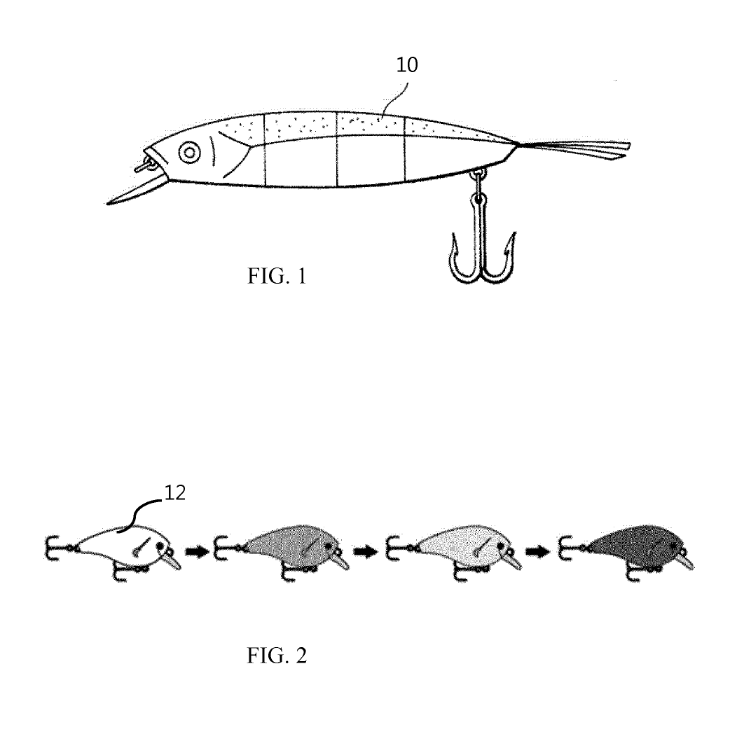

### DETAILED DESCRIPTION

### Best Mode of Embodying the Invention

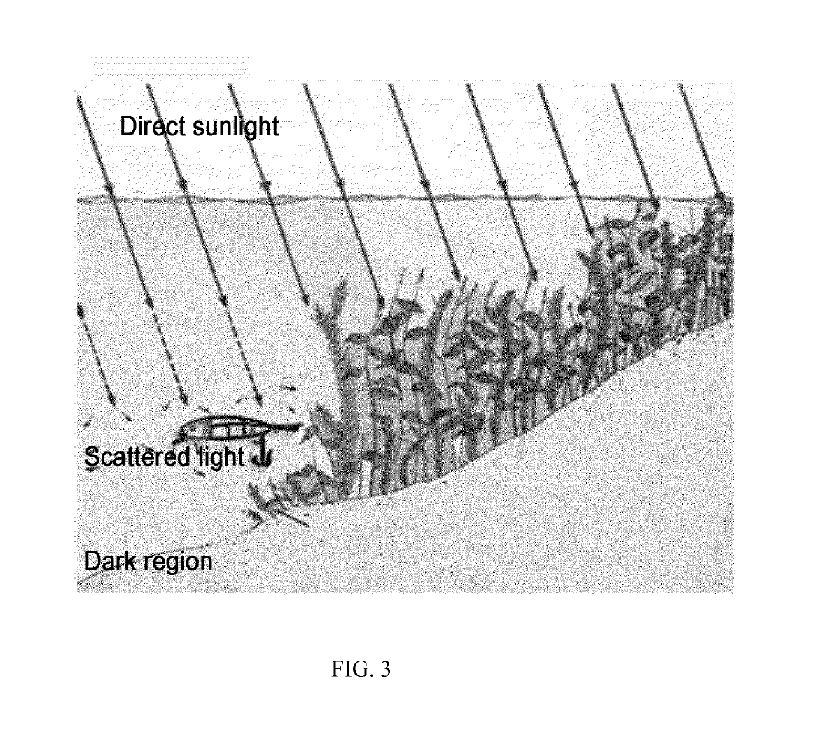

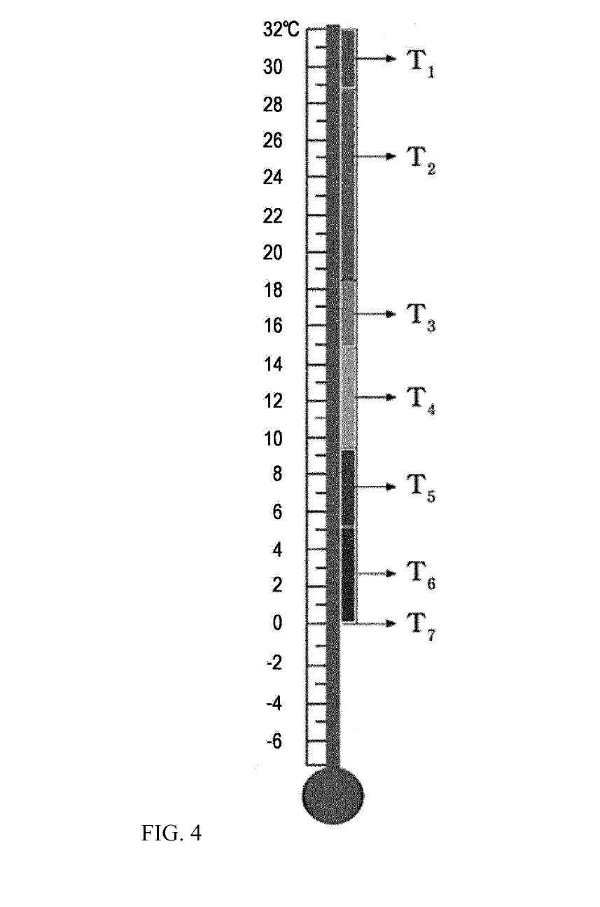

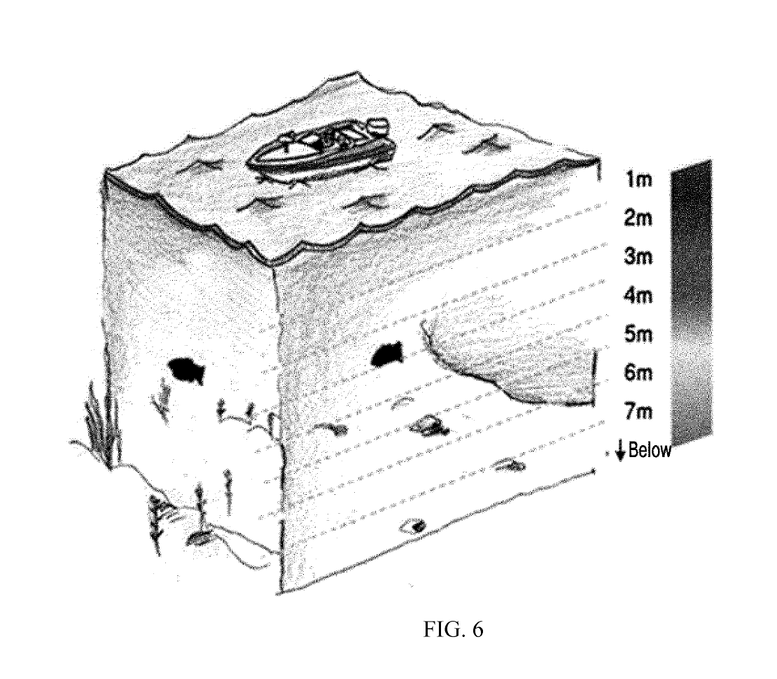

The multicolored artificial bait (12) according to one embodiment of the invention will be described with reference to FIGS. 2 through 6.

The term “clear water” used in this invention and throughout the specification is defined as water that has a pH, which indicates acidity, neutrality, or alkalinity, of 7.0-7.5 (standard: 5.8-8.5); a turbidity, which indicates the opacity of water, of 0.05-0.15 NTU (standard: 0.5 NTU or below), and is also within all other standard ranges e.g. for evaporation residue (which has an aesthetic impact), hardness, etc.

In addition, the term “muddy water” used in this invention and throughout the specification is defined as water that has a pH (hydrogen ion concentration), which indicates acidity, neutrality, or alkalinity, of either less than 5.5 or greater than 9.0; and a turbidity, which indicates the opacity of the water, exceeding 5 NTUs (Nephelometric Turbidity Units), or exceeding 1 NTU over a period of at least 24 hours.

Although the artificial bait according to the embodiment of this invention can be used on any kind of fish, it is preferred that it be used on perciform fish.

In addition, said perciform fish can be any one selected from among the group comprising the Percichthyidae, Serranidae, Polyprionidae, Nototheniidae, Moronidae and Centrarchidae, but is not limited thereto.

In addition, said perciform fish can be any one selected from among the group comprising Australian bass (Macquaria novemaculeata), black sea bass (Centropristis striata), giant sea bass (Stereolepis gigas), Patagonian toothfish (Dissostichus eleginoides), European seabass (Dicentrarchus labrax), largemouth bass (Micropterus salmoides), smallmouth bass (Micropterus dolomieu), striped bass (Morone saxatilis), and spotted bass (Micropterus punctulatus), but are not limited thereto. This specification describes a multicolored artificial bait suitable for “bass,” which are known as one type of perciform game fish, typically including the above-mentioned species.

Bass eat crustaceans and small fish in streams and lakes with no water flow; the males build nests to attract females to lay their eggs, and defend the nests after the eggs have been laid.

In addition, bass have a head and body that are flattened on each side; the body is long and tapered at each end. The head is large; the eyes are comparatively small, and the mouth is long and tapered at each end. In addition, the mouth is large, and the lower jaw projects forward past the upper jaw; there are two dorsal fins, and the center of the rear end of the caudal fin is concave and there is a long bluish-brown stripe on the center of either side of the body.

Because the eyes of the above-described bass face upward on top of the head, bass have a 360-degree field of vision. Their sensory organs include rod cells and cone cells; the rod cells discriminate between light and darkness, and the cone cells distinguish colors.

The rod cells respond sensitively to faint blue and green light, and because rod cell development is good for night vision, bass can engage in food-seeking even on very dark nights. Their visual acuity is limited by the turbidity of the water, and may change with depth. In very clear water, they can see up to about 30 m. Bass habitually use their vision whenever they can, to identify dangers and seek food. They use other senses to gather additional information, transmit warnings, or supplement the vision when it is limited. The two sets of cone cells respond most sensitively to red, orange and green wavelengths; bass can detect diverse colors during the day or at dawn or sunset, etc.

Bass exhibit the ability to distinguish even very small differences in red, orange and green light; they can definitely also distinguish dark blues and bright yellows to some degree. Therefore, it is clear that they are able to discriminate between colors, and recognize various types of stimuli with respect to color.

The multicolored artificial bait according to one embodiment of this invention has a plurality of pre-set temperature zones, and contains microcapsules that manifest a pre-set color corresponding to the respective temperature zone.

Said microcapsules are a substance that manifests a pre-set color with respect to the temperature zones pre-set for the artificial bait; according to one embodiment of this invention, they may be a mixture containing one or more of temperature-sensitive microcapsules and light-sensitive microcapsules.

Said temperature-sensitive microcapsules or light-sensitive microcapsules may be manufactured directly, or obtained from a commercial supplier. The temperature-sensitive microcapsules and light-sensitive microcapsules of Polychrom Corp. are a representative example.

The artificial bait containing said microcapsules changes color in response to the transmission of sunlight or the temperature at a given depth.

Said microcapsules must be of an appropriate weight to manifest the pre-set colors; in one embodiment of this invention, they may be between 0.1 and 5% of the total weight.

In addition, the multicolored artificial bait may also be in any form that changes color with the water temperature at a given depth or the transmission of sunlight at a given depth; by way of example, they may be in the form of a fish or a straight line.

In addition, said plurality of pre-set temperature zones is determined by one or more from among the transmission of sunlight and temperature at a given depth.

FIG. 4 illustrates more specifically the relationship between bass and water temperature; the relationships between bass and the temperature ranges T1-T7 are as follows.

T1: The concentration of dissolved oxygen in the surface layer is reduced. Bass activity is nearly stopped, and bass frequently leave their habitat and engage in suspending. If possible, bass will seek out areas where springs rise, shoreline areas exposed to wind, or alleys, etc.; they engage in food-seeking chiefly at night.

T2: Post-spawn; the deep water layers are the principal point of attack for bass fishing. When the water temperature continuously rises to reach the 24-25° C. that is optimal for bass, the bass disperse to the respective parts of the lake.

T3: Spawn

T4: Pre-spawn; except when cold fronts strike, the bass approach the central depths or near-shore shallows, seeking appropriate places to spawn.

T5: When warm weather over several days has raised the water temperature by 1-2° C., the conditions are very good for fishing.

T6: Warmth is present, but bass are still in a very lethargic state.

T7: Frozen

Water is generally categorized as clear, stained or muddy; “stained water” typically refers to greenish water, and the majority of Korean reservoir water is stained water.

In water of this kind, the quantity of sunlight that gradually makes its way through the water is reduced, with the greatest amount being lost at short wavelengths (purple, blue), while long wavelengths (red) penetrate to the deepest places.

Thus, some colors may not be visible at certain turbidities and depths.

Because bass are cold-blooded animals, when a change in water temperature occurs, they undergo a physiological change to match their own body temperature to the changed water temperature. When the water temperature rises slowly, bass return to activity and engage in full food-seeking activity, and likewise, when water temperature falls, the movement of the bass is minimized. Bass move to seek the temperature most suited to them, and are constantly moving along the thermocline to find the appropriate temperature at which they can feed actively.

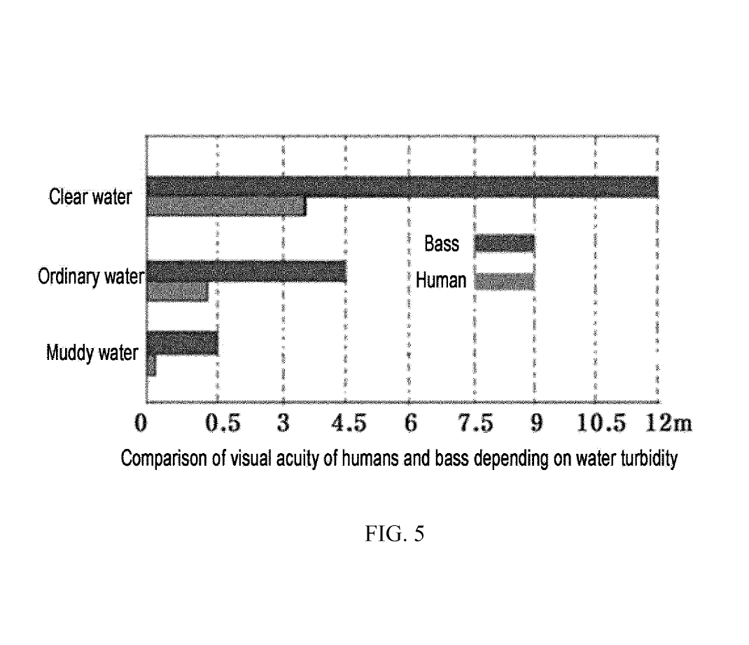

FIG. 5 shows the relationship of the growth of aquatic plants and phytoplankton to the degree of transmission of light; as shown, the growth of aquatic plants and phytoplankton is determined by the transmittance of sunlight; when water temperature is increased by sunlight, nutrient salts of nitrogen, phosphorus, etc. are increased (wastewater and stormwater intake) and the green algae phytoplankton multiply to cover the surface of the lake, consequently blocking the sunlight so that the dissolved oxygen (DO) in the water is reduced and aquatic biota are killed off, polluting and turbidifying the water.

In addition, the water temperature is determined by said sunlight transmission and temperature at said given depth. Specifically, said plurality of temperature zones can ultimately be determined by water temperature.

In addition, said plurality of pre-set temperature zones can be determined arbitrarily according to user intent or purpose; by way of example, it may comprise four zones based on depth. According to one embodiment of this invention, said four zones are divided into a 1st zone, 2nd zone, 3rd zone, and 4th zone, at intervals of 2 m from the water surface.

Here, the term “zone” technically denotes a place where some property of the water changes abruptly. If the water temperature at various depths is graphed, the place where the water temperature changes abruptly is manifested by a bend in the line. A place where the water temperature changes in this abrupt fashion are referred to as a “thermocline” (or thermocline zone); warmed water is lighter than cold water, and unless it is forced to flow downward (e.g. due to wastewater discharge or precipitation), a thermocline (or thermocline zone) is formed at a depth where the water does not mix with heavier water from deeper down. In the case of a small reservoir with shallow water, a thermocline (or thermocline zone) is formed at a depth of 1 m-2 m due to the absorption of heat from the water surface to the bottom. In the case of clear water through which sunlight can penetrate more deeply, e.g. in larger reservoirs with a depth of 5 m-10 m, a thermocline may be formed at a greater depth.

If there is a change in external environmental factors, such as a strong wind or rainfall, the thermocline (or thermocline zone) is destroyed and a new thermocline (or thermocline zone) is formed at a greater depth; if warm and mild weather continues, a new thermocline (or thermocline zone) may also be formed above the previous thermocline (or thermocline zone).

Several thermoclines (or thermocline zones) may also overlap depending on various environmental factors such as reservoir shape and size or changes in climate.

It is preferred that the multicolored artificial bait according to one embodiment of this invention manifest mutually-distinct colors in said four zones; more specifically, it is preferred that said multicolored artificial bait manifest at least one or more colors selected from among the group comprising white, blue and purple in said 1st zone; a green-type color in said 2nd zone; at least one from among gold-type and pink-type colors in said 3rd zone; and a red-type color in said 4th zone.

The change in color of the artificial bait that changes color according to water temperature is shown in FIG. 2. This selection of colors is in order to achieve the most efficient catch performance by using the color that is most clearly visible to the eyes of bass in the relevant zone.

In addition, the method of manufacturing the above-described artificial bait involves steps of forming a mixture by mixing temperature-sensitive microcapsules and light-sensitive microcapsules with a plastic resin, and extruding said mixture. The artificial bait thus extrusion-formed may be of a hard material.

In addition, said method involves steps of forming a mixture by mixing temperature-sensitive microcapsules and light-sensitive microcapsules with a plastic resin, and casting said mixture.

In addition, as described hereinabove, the plurality of temperature zones are mutually distinct based on the temperature or sunlight transmission at a given depth. In other words, the tendency of water temperature to decrease with increasing depth is not fixed, and depending on the season, the water temperature may also increase with increasing depth; thus, the multicolored artificial bait of this invention that responds to water temperature rather than depth may be more efficient.

Said formation of four zones is determined by the characteristics of the location of use, such as reservoir dam boundary; the pre-set temperatures based thereon may also be applied differently to suit the characteristics of the location of use.

Thus, the manufacture of a multicolored artificial bait that changes color in response to pre-set temperatures depending on depth and changes in water temperature, and is sensitive to the local environment and water temperature based on the ecological characteristics of bass, has the technological benefit of enabling more effective bass fishing.

A person having ordinary skill in the art can determine, based on the information explained above, that diverse alterations and adjustments are possible without departing from the technical ideas of this invention. The technical scope of the present invention must therefore not be construed to be limited by the disclosures made in the specification, but must be determined solely by the scope of the patent claims.

What is claimed is:

1. A multicolored artificial bait, used for catching perciform fish, having a plurality of pre-set temperature zones, and containing microcapsules that manifest a pre-set color corresponding to the respective temperature zone.

2. The multicolored artificial bait according to claim 1, wherein said perciform fish is any one selected from among the group comprising the Percichthyidae, Serranidae, Polyprionidae, Nototheniidae, Moronidae and Centrarchidae.

3. The multicolored artificial bait according to claim 1, wherein said perciform fish is any one selected from among the group comprising Australian bass (Macquaria novemaculeata), black sea bass (Centropristis striata), giant sea bass (Stereolepis gigas), Patagonian toothfish (Dissostichus eleginoides), European seabass (Dicentrarchus labrax), largemouth bass (Micropterus salmoides), smallmouth bass (Micropterus dolomieu), striped bass (Morone saxatilis), and spotted bass (Micropterus punctulatus).

4. The multicolored artificial bait according to claim 1, wherein said microcapsules are one or more of temperature-sensitive and light-sensitive.

5. The multicolored artificial bait according to claim 1, wherein said plurality of pre-set temperature zones are determined by at least one or more of sunlight transmission and water temperature at a given depth.

6. The multicolored artificial bait according to claim 1, wherein said microcapsules are recognized by said perciform fish at 12 m or less in the case of clear water, 4.5 m or less in the case of ordinary water, and 0.5 m or less in the case of muddy water.

7. The multicolored artificial bait according to claim 6, wherein said plurality of pre-set temperature zones comprise four zones based on depth, and said four zones are a 1st zone, 2nd zone, 3rd zone, and 4th zone at intervals of 2 m from the water surface.

8. The multicolored artificial bait according to claim 7, wherein in said 1st zone, said multicolored artificial bait manifests at least one or more colors selected from among the group comprising white, blue, and purple.

9. The multicolored artificial bait according to claim 7, wherein in said 2nd zone, said multicolored artificial bait manifests a green-type color.

10. The multicolored artificial bait according to claim 7, wherein in said 3rd zone, said multicolored artificial bait manifests at least one or more colors from among gold-type and pink-type colors.

11. The multicolored artificial bait according to claim 7, wherein in said 4th zone, said multicolored artificial bait manifests a red-type color.

12. The multicolored artificial bait according to claim 1, wherein said microcapsules are comprise between 0.1 and 5% of the total weight.
